(19) United States
(12) Patent Application Publication
(10) Pub. No.: US 2024/0144309 A1
(43) Pub. Date: May 2, 2024

(54) SYSTEM AND METHOD FOR AGGREGATION AND INTEGRATION OF HYDROGEN PRODUCTION, STORAGE, AND DISTRIBUTION TO SUPPORT AND OPTIMIZE NORMALIZATION OF HYDROGEN

(71) Applicant: Independence Hydrogen Inc., Leesburg, VA (US)

(72) Inventors: Scott Gerald BORGERSON, Manchester, MA (US); Matthew Robert LETARTE, Alexandria, VA (US); Nicholas McAvoy PARKER, Marietta, GA (US); William David LEHNER, Leesburg, VA (US); Owen Francis BARWELL, Evergreen, CO (US)

(21) Appl. No.: 18/495,456

(22) Filed: Oct. 26, 2023

Related U.S. Application Data
(60) Provisional application No. 63/419,587, filed on Oct. 26, 2022.

(51) Int. Cl. G06Q 30/0201; G06Q 30/018

(52) U.S. Cl. CPC G06Q 30/0206; G06Q 30/018

(57) ABSTRACT

An apparatus for providing normalized hydrogen correction factor comprises: a set of sensors configured to measure telemetry data of a hydrogen production plant; a memory; a database; and a processor operatively coupled to the memory, the database, and the set of sensors. The processor is configured to: receive the telemetry data from the set of sensors; receive supplier data from the database; receive customer data from a customer; determine, using a machine learning model stored in the memory, and based on the telemetry data, the supplier data, and the customer data, a normalized hydrogen correction factor; and provide the normalized hydrogen correction factor to the customer.

### CROSS REFERENCE TO RELATED APPLICATION

This application priority to Provisional U.S. Patent Application No. 63/419,587, filed on Oct. 26, 2022, the entire disclosure of which is hereby incorporated by reference.

### FIELD

This disclosure relates generally to the exchange and purchase of hydrogen, and more particularly, to systems and methods for aggregation and integration of hydrogen production, storage, and distribution to support and optimize normalization of hydrogen.

### BACKGROUND

Hydrogen provides the means of both the storage and transport of energy. As an energy carrier, it is a commodity like the other carriers (e.g., electricity, coal, natural gas, gasoline). Hydrogen can be produced from diverse sources, including fossil fuels, biomass, industrial waste, and electrolysis, and then can be consumed in any sector: transportation, electric, natural gas, or even utilized as a feedstock in many industries.

Hydrogen can support a broad range of applications. This includes distributed or combined-heat-and-power; backup power; systems for storing and enabling renewable energy; portable power; auxiliary power for trucks, aircraft, rail, and sea vessels; specialty vehicles such as forklifts; and passenger and freight vehicles including cars, trucks, and buses. For industrial applications, hydrogen has the potential to replace natural gas for heating and electricity generation by co-generation or by blending directly into the natural gas grid. Hydrogen can provide a feedstock in industries such as oil refineries, ammonia production, metallic ore reduction, hydrochloric acid production, hydrogenating agent, atomic hydrogen welding, methanol production, manufacture of hydrogen peroxide, gas chromatography, chemical analysis, weather balloons, coolant, searching gas, reducing agent, etc. Gaseous hydrogen can be transported physically through a number of means, including road, rail, sea, air, or pipeline transport. Hydrogen can also be transported on an energy basis through the natural gas or electrical grids. Hydrogen can be transported in a gaseous or liquid state.

Depending on method of production, transportation, and distribution, and feedstock used to produce hydrogen, the realized carbon intensity (CI) for hydrogen utilization can be very different. Existing descriptors of CI frequently rely on qualitative, imprecise, and sometimes arbitrary “colors” of hydrogen. For example, what is typically referred to as “green hydrogen” may be produced from water through an electrolysis process by employing renewable electricity. What is typically referred to as “blue” hydrogen is sourced from fossil fuel with the carbon dioxide captured and stored underground. What is typically referred to as “grey” hydrogen is produced from fossil fuel and commonly uses steam methane reforming with carbon dioxide being the only waste product. Such labels, however, are frequently misleading and/or inaccurate. A need therefore exists for techniques that consider and/or normalize hydrogen based in part on a quantitative measure of CI that includes the total product lifecycle including, feedstock, production, storage, transportation, and delivery to the end use application.

The demand for hydrogen, which has grown more than threefold since 1975, continues to rise. With the technological advances which are making hydrogen production, distribution, and storage more efficient and cheaper, and governments' commitments to decarbonize, the hydrogen market size is expected to grow to from USD 150.20 billion in 2021 to USD 220.37 billion in 2028. According to International Renewable Energy Agency, hydrogen will account for 12% of global energy use by 2050. The Infrastructure Investment and Jobs Act (IIJA) enacted in November 2021 requires the Department of Energy (DOE) to fund at least four regional hydrogen hubs with an S8 billion investment distributed from fiscal years 2022-2026 to meet the increasing demand of hydrogen.

Commodities and energy carriers need markets. However, the hydrogen market is less mature than the other commodity and energy carrier markets, and there is no market standard for hydrogen purchase contract or spot price for hydrogen. Currently, hydrogen purchase contracts in the market are mostly single-maker, single-user contracts, or stated differently, bilateral producer-consumer contracts. In addition, the world's hydrogen producers generally do not provide transparent pricing for hydrogen contracts.

In contrast to hydrogen, a mature market for pricing and trading other commodities and energy carriers, such as fossil fuels and uranium, exists. For example, spot and future liquid natural gas (LNG) prices set at Henry Hub provide market transparency. The hydrogen market does not have the same level of market transparency, and, in addition, factors such as production cost, infrastructure investments, storage cost, transport cost, safety consideration, and matching supply-demand uncertainties are among the known challenges for hydrogen market growth and development. While, like LNG and other commodities, the end hydrogen product is fungible, unlike other known commodities with established markets, environmental, differences in upstream production and transport factors that are not discernable though examination of the end product can have a significant impact on hydrogen value regularity, and tax factors. Thus, there exists a need for an improved method for normalization of hydrogen with a common, universal, and standardized measurement.

### SUMMARY

In some embodiments, an apparatus for providing normalized hydrogen correction factor comprises: a set of sensors configured to measure telemetry data of a hydrogen production plant; a memory; a database; and a processor operatively coupled to the memory, the database, and the set of sensors. The processor is configured to: receive the telemetry data from the set of sensors; receive supplier data from the database; receive customer data from a customer; determine, using a machine learning model stored in the memory, and based on the telemetry data, the supplier data, and the customer data, a normalized hydrogen correction factor; and provide the normalized hydrogen correction factor to the customer.

In some embodiments, a method for providing normalized hydrogen correction factor, comprises receiving telemetry data from a set of sensors; receiving supplier data from a database; receiving customer data from a customer. The method further includes determining, using a machine learning model stored in a memory, and based on the telemetry data, the supplier data, and the customer data, a normalized hydrogen correction factor; and providing the normalized hydrogen correction factor to the customer.

In some embodiments, a non-transitory computer readable medium having stored therein instructions executable by a processor, the instructions are executable to: receive telemetry data from a set of sensors; receive supplier data from a database; receive customer data from a customer. The instructions are further executable to determine, using a machine learning model stored in a memory, and based on the telemetry data, the supplier data, and the customer data, a normalized hydrogen correction factor. The instructions are executable to provide the normalized hydrogen correction factor to the customer.

### BRIEF DESCRIPTION OF THE DRAWINGS

FIG. 1 is a schematic illustration of dataflow in a system for exchanging normalized hydrogen metric, according to an embodiment.

FIG. 2 is a block diagram of a system for exchanging normalized hydrogen metric, according to an embodiment.

FIG. 3 is a flow diagram of a method for exchanging normalized hydrogen metric, according to an embodiment.

### DETAILED DESCRIPTION

System and method for providing normalized hydrogen correction factor are described herein. With the increasing demand and growing market size for hydrogen, the hydrogen market is expected to grow and evolve similarly to other kinds of commodity and energy markets, such as LNG. Hydrogen, however, is considerably more physically variable than most or all other commodities, in that myriad factors such as feedstock, energy costs, infrastructure investments, storage cost, transport cost, safety consideration, etc. influence the price a supplier is willing to accept and a similarly large number of factors, such as CI, state (liquid or gas), pressure, grade delivery destination, etc. influence the price a customer is willing to pay. Some or all of these factors are not fully addressed in existing commodities markets. Furthermore, in many existing cases, CI of hydrogen is imprecisely and/or inaccurately qualitatively identified by “color.” Embodiments described herein, however, rely on accurate quantitative measures of CI, such as a score calculated using, for example, the U.S. Department of Energy's Greenhouse gases, Regulated Emissions, and Energy use in Technologies (GREET) model and/or other suitable quantitative models or metrics, such as the California Low Carbon Fuel Standard (LCFS) score. Therefore, embodiments described herein generally relate to systems and techniques for analyzing hydrogen and providing or calculating normalized correction factors that can be used in a common, universal measurement for exchanging hydrogen against an index/benchmark valuation for hydrogen that is similar to what Henry Hub is for natural gas, but without the upstream-related complications, which can improve the ability of producers and consumers to buy, sell, and/or exchange hydrogen. By way of analogy, Henry Hub gas prices reflect the price of gas traded in the US and are used to price LNG exports from the US, but the LNG industry has also factored in market-based pricing for LNG to reflect demand-supply fundamentals in end-user markets like Asia. Given the complex factors to consider in exchanging hydrogen, there exists a need for an improved method for exchanging hydrogen with normalized correction factor.

In an example, a standard unit of hydrogen can be defined, for example:
CI_{A}: 0.45 kg CO₂/kg H₂
Location: Richmond, VA
P_{A} SAE J2719 grade
Quantity: 1 metric ton

| Metric name | Metric meaning |
|---|---|
| P_{A} | Available purity for hydrogen |
| CI_{A} | Available carbon intensity for hydrogen (e.g., |
| | GREET score or other suitable metric) |

The standard unit of hydrogen can represent a “default” or convenient unit suitable for buying and/or selling. The price of the standard unit of hydrogen can represent a spot price of hydrogen and can be set by any suitable means, but would typically be set by market forces, as discussed in further detail herein. In this particular example, the price for a standard unit of hydrogen can be the cost at which 1 metric ton of SAE J2719 grade hydrogen with a GREET score of 0.45 kg CO₂/kg H₂ is available in Richmond, Virginia. It should be understood, however, that any suitable measure of carbon intensity, any suitable location, any suitable grade, and/or any suitable measure of quantity can be used to define a standard unit of hydrogen.

Most producers and consumers of hydrogen, however, do not produce “standard” hydrogen and/or even were a spot price of hydrogen to exist, many producers and consumers of hydrogen would not offer to buy or sell hydrogen at that spot price. For example, hydrogen with a CI other than 0.45 kg CO₂/kg H₂, with a grade other than SAE J2719, and/or available at/delivered to a location other than Richmond, Virginia, and/or trading at a different volume would deviate from the standard unit. Embodiments described herein generally relate to systems and methods for evaluating the difference in value between a standard unit of hydrogen and an arbitrary unit of hydrogen. Currently, no standard unit of hydrogen or spot price of hydrogen exists, because of the technical challenges inherent to the large number of inter-related value-affecting aspects of hydrogen. The technical challenges in evaluating an arbitrary unit of hydrogen are even more complex, as value of hydrogen can change in complex and non-linear ways with CI, location, grade, quantity, state (e.g., liquid or gaseous), pressure, mode of transport (e.g., tanker truck, rail, pipeline), and even units of measurement (e.g., value may differ between a unit measured in metric tons and a unit measured in standard cubic feet even if the measures are nominally equivalent).

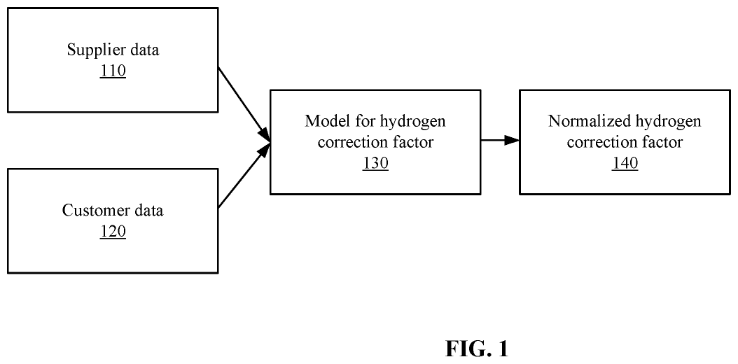

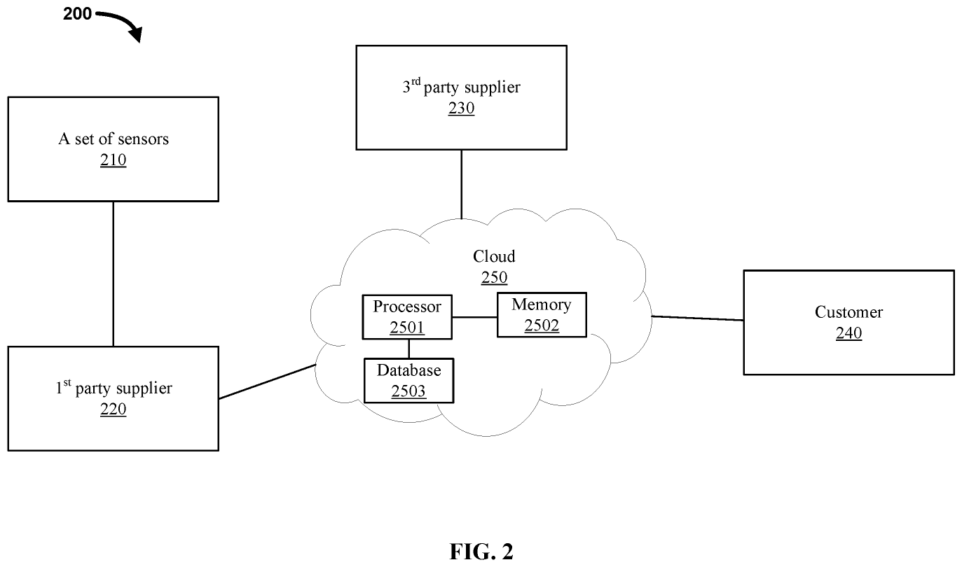

To overcome these challenges, systems and methods are described herein for providing normalized hydrogen correction factor. FIG. 1 is a schematic illustration of dataflow in a system for providing normalized hydrogen correction factor, according to an embodiment. As shown in FIG. 1, supplier data 110 and customer data 120 are received in a machine learning model for providing normalized hydrogen correction factor 130. The machine learning model 130 calculates, based on the supplier data 110 and the customer data 120, to output a new, common, universal, standardized measurement of hydrogen. This new, common, universal, standardized measurement of hydrogen is called normalized hydrogen correction factor 140. Using the normalized hydrogen correction factor 140, exchanging or trading of hydrogen from distributed and different suppliers can be done with a common, universal, and normalized standard. In addition, derivatives (not shown, e.g., futures, options, forwards, and swaps) of the hydrogen with the normalized hydrogen correction factor 140 can also be calculated and provided to the customer for exchanging. Components in the system for providing normalized hydrogen correction factor are described in detail below in FIG. 2.

FIG. 2 is a block diagram of a system 200 for providing normalized hydrogen correction factor, according to an embodiment. As shown in FIG. 2, the system 200 includes a set of sensors 210, a first-party supplier 220 operatively coupled with the set of sensors 210, a cloud 250 operatively connected with the first party supplier 220 through a communications network (not shown). A third-party supplier 230 is also operatively connected with the cloud 250. A customer 240 is operatively connected with the cloud 250. The cloud 250 includes a processor 2501, a memory 2502 operatively coupled to the processor 2501, and a database 2503 operatively coupled to the processor 2501.

The processor 2501 can perform (or cause to be performed) any of the techniques discussed herein. The processor 2501 can be or include, for example, a hardware-based integrated circuit (IC) or any other suitable processing device configured to run and/or execute a set of instructions or code. For example, the processor 2501 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor 2501 can run any of the methods and/or portions of methods discussed herein. Although as shown in FIG. 2 the processor 2501 is included in the cloud 250, in alternative implementations, the processor 2501 can be located locally with the first party supplier 220 and/or the third-party supplier 230.

The memory 2502 can be, for example, a random-access memory (RAM), a memory buffer, a hard drive, a read-only memory (ROM), an erasable programmable read-only memory (EPROM), and/or the like. The memory 130 can store sensor data collected by the set of sensors 210, and any other data used by the processor 2501 to perform the techniques discussed herein. In some instances, the memory 2502 can store, for example, one or more software programs and/or code that can include instructions to cause the processor 2501 to perform one or more processes, functions, and/or the like. In some implementations, the memory 2502 can include extendible storage units that can be added and used incrementally. In some implementations, the memory 2502 can be a portable memory (for example, a flash drive, a portable hard disk, and/or the like) that can be operatively coupled to the processor 2501. In some instances, the memory 2502 can be remotely operatively coupled to the processor 2501. For example, a remote database device can serve as a memory and be operatively coupled to the processor 2501. The processor 2501 can access data stored on the memory 2502; for example, the processor 2501 can access at least the data collected by the set of sensors 210 and stored in the memory 2502.

The memory 2502 can store the instructions that can be executed by the processor 2501, and/or data detected by the set of sensors 210. The memory 2501 can store one or more software algorithm(s) (not shown). The software algorithm(s) can be, for example, an artificial intelligence (AI) model(s) or algorithm(s), a machine learning (ML) model(s) or algorithm(s), an analytical model(s) or algorithm(s), a rule-based model(s) or algorithm(s), or a mathematical model(s) or algorithm(s). After the processor 2501 has received the sensor data collected by the set of sensors from the first party supplier 220, supplier data from the third-party supplier 230, and customer data from the customer 240, the processor 2501 can process the data using software algorithm(s) to calculate and output a hydrogen metric to provide to the customer 240.

The first party supplier 220 and/or the third-party supplier 230 can be any type of hydrogen production plant. For example, the first party supplier 220 and/or the third-party supplier 230 can be steam methane reforming plant for producing hydrogen using feedstock such as natural gas, renewable natural gases, naphtha, etc. Approximately 50% of the worlds hydrogen is being produced by this type of plant. Alternatively, the first party supplier 220 and/or the third-party supplier 230 can be electrolysis hydrogen production plant which uses electricity to split water into hydrogen and oxygen. In addition, the first party supplier 220 and/or the third-party supplier 230 can be methane pyrolysis plant, partial oxidation plant, plasma reforming plant, coal gasification plant, petroleum coke for producing hydrogen, or any other suitable source for the production of hydrogen.

The set of sensors 210 can include any type of sensor that is capable of measuring data for first party supplier 220 facilitating calculation of normalized hydrogen correction factor. The data collected from the set of sensors 210 can include volume data, location data, purity data, carbon intensity data, pressure data, transportation data, and/or utility data for the first party supplier 220. The utility data can include natural gas data, water data, electricity data, and/or liquid nitrogen data. The set of sensors 210 can include catalytic sensors, electrochemical sensors, infrared sensors, pressure sensors, and hydrogen purity sensors etc. and any additional sensors that can measure the useful data for the first party supplier 220.

In some embodiments, the database 2503 can be a distributed database. For example, the database 2503 can be a block chain, which receives data for storage from a plurality of first party supplier 220 and/or third-party supplier 230. The entities (e.g., first party supplier 220 and/or third-party supplier 230) need not be related, and the type of data need not be the same. In general, entities (e.g., first party supplier 220 and/or third-party supplier 230) committing data to the block chain are unrelated, and the type of data can vary to almost any type of digital data. Thus, the data received for storage is configured to be processed to generate a transaction record that is dependent on previous data stored to the block chain. The transaction record being dependent on previous data stored to the block chain ensures that data stored to the block chain is not modifiable, as each later data stored to the block chain continues to be dependent on previous data stored to the block chain. For example, volume data, location data, purity data, carbon intensity data, pressure data, transportation data, and/or utility data from first party supplier 220 and/or third-party supplier 230 are saved in the database 2503 (e.g., block chain), the processor 2501 can access the data safely and generate a standard hydrogen metric with a machine learning model or software algorithm stored in the memory 2502.

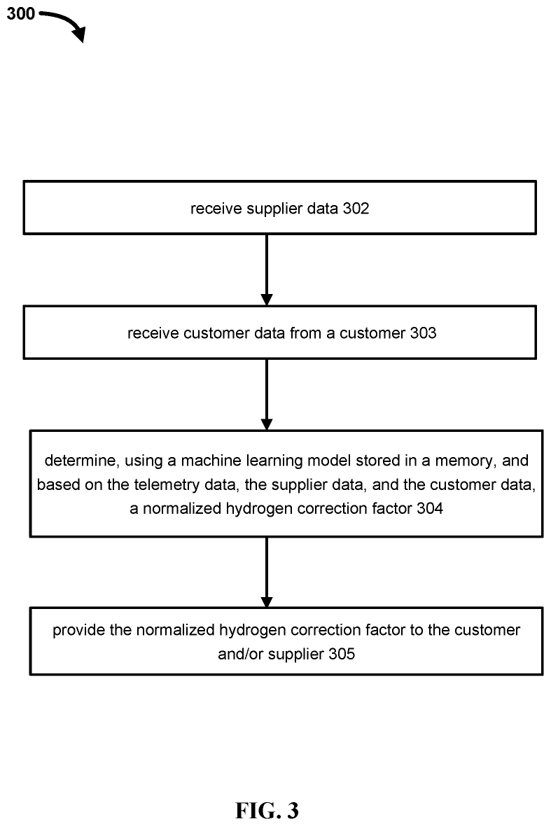

The customer 240 can be any type of hydrogen consumers. For example, the customer 240 can be oil refineries and/or fertilizer producers. Alternatively, the customer 240 can also use hydrogen to provide energy in a board range of applications such as transportation, commercial, industrial, residential, and portable. Methods for providing normalized hydrogen correction factor are described in detail below in FIG. 3.

FIG. 3 is a flow diagram of a method for providing normalized hydrogen correction factor, according to an embodiment. The method 300 of FIG. 3 can be implemented, for example, using the processor 2501 in FIG. 2. As shown in FIG. 3, at 301, the method begins with receiving supplier data 302. In some instances, the supplier data can be received from a set of sensors (e.g., sensors 201). In some implementations, the telemetry data includes volume data, location data, purity data, carbon intensity data, pressure data, transportation data, and/or utility data. In some implementations, the utility data includes natural gas data, water data, electricity data, and liquid nitrogen data. The supplier volume data can be, for example, a volume of hydrogen produced and/or available for sale and may be measured in kilograms or at a given or standard temperature, pressure and/or volume. The processer converts the various units of measure (Standard Cubic Feet (SCF), Centum Cubic Feet (CCF), Million British Thermal Units (MMBTU), etc., to a common base unit of kilogram. The supplier location data can be, for example, the location for hydrogen production site and/or location of hydrogen available for sale. The purity data can be hydrogen purity or hydrogen quality data that describes the presence of impurities in hydrogen when used as a fuel gas. Normative bodies have issued quality standards for hydrogen purity. For example, international standard ISO 14687, defines maximum impurity for hydrogen quality for road vehicles. A European standard, EN 17124, has been approved in 2018 with the same maximal levels of impurities as in ISO 14687. Society of Automotive Engineers (SAE), an international association issuing standards for mobility, has also developed a standard for hydrogen purity SAE J2719, applicable in the USA. Supplier carbon intensity data can be, for example, a GREET score, number of kilograms of carbon dioxide (CO₂) it takes to make a given kilogram of hydrogen, and/or other suitable quantitative measure of carbon intensity. Because carbon intensity not only depends on the production method of hydrogen, but also depends on feedstock used to produce hydrogen, it is important to measure the overall carbon intensity data accurately. Supplier carbon intensity data can be calculated by software algorithm(s), such as an artificial intelligence (AI) model(s) or algorithm(s), a machine learning (ML) model(s) or algorithm(s), an analytical model(s) or algorithm(s), a rule-based model(s) or algorithm(s), or a mathematical model(s) or algorithm(s). Alternatively, the supplier carbon intensity data can be provided by a party that has hydrogen available for sale. Supplier pressure data can be a pressure at which the (gaseous) hydrogen is shipped (e.g., via trailer, train car, pipeline) or an indication that the hydrogen is liquified. The supplier transportation data can be, for example, transportation cost at hydrogen production site or location that has hydrogen available for sale. For example, gaseous hydrogen can be transported from the point of production to the point of use via pipeline. Alternatively, hydrogen can also be transported in liquid form and over the road in cryogenic liquid tanker trucks. Supplier utility data can be, for example, utility cost during hydrogen production. The utility data can be measured from sensors and/or telemetry, and/or provided by a party that has hydrogen for sale. Utility data can include: natural gas data (i.e., cost of natural gas in production of hydrogen), electricity data (i.e., cost of electricity in production of hydrogen), water data (i.e., cost of water in production of hydrogen, including wastewater), and liquid nitrogen data (i.e., cost of liquid nitrogen in liquefaction of hydrogen). In some implementations, the supplier utility data includes supplier natural gas data, supplier water data, supplier electricity data, and supplier liquid nitrogen data. In some embodiments, the database is a distributed database in the form of a block chain. The supplier data can be provided by third party suppliers. In some instances, the third-party suppliers can be compensated for providing data from transaction fees associated with exchanging of hydrogen and/or futures and/or other transactions associated with the exchanging and/or sale of hydrogen. For example, half of the profit from hydrogen metrics exchanging can go to the third-party suppliers to incentivize more third-party suppliers to provide data to form more exchanging of hydrogen metrics. Supplier data can be received via any suitable means, such as telemetry data directly from supplier sensors, manually entered via webform or mobile app, transmitted via fax, mail, or telephone, received from data brokers, etc. Supplier data can be received at any suitable frequency, such as per discrete lot of hydrogen produced/stored, periodically based on volume produced, daily, weekly, monthly, etc. In some embodiments, supplier data includes sales data, such as a price per quantity at which hydrogen specified by, for example volume data, location data, purity data, carbon intensity data, pressure data, transportation data, and/or utility data was sold. Supplier data can also include delivery data (e.g., where and how hydrogen was delivered) and/or information associated with the customer to whom the supplier sold hydrogen.

At 303, the method continues with receiving customer data from a customer. The customer data can include customer volume data, customer location data, customer purity data, customer carbon intensity data, customer pressure data, and/or customer transportation data. In some embodiments, customer data can include sales data, such as a price per quantity at which hydrogen specified by, for example volume data, location data, purity data, carbon intensity data, pressure data, transportation data, and/or utility data was purchased. Customer data can also include delivery data (e.g., where and how hydrogen was delivered) and/or information associated with the supplier from whom the customer purchased hydrogen.

At 304, the method continues with determining, using a machine learning model stored in a memory, and based on the supplier data and the customer data, a spot price and/or a normalized hydrogen correction factor. For example, transaction data for past sales of hydrogen, received with supplier data and/or customer data, can be used to train a machine learning model.

Typically, customer data and supplier data are received from multiple customers and suppliers. The machine learning model can be trained to calculate a spot price for a standard unit of hydrogen and/or normalized hydrogen correction factor(s), NHCFs, for arbitrary unit(s) of hydrogen may be based on any number of inputs, such as price (e.g., per unit volume), volume, and/or any suitable metrics shown in Table 1 below:

TABLE 1
Machine learning model inputs and outputs for
providing normalized hydrogen correction factor

| Metric name | Metric meaning |
|---|---|
| V_{R} | Required volume for hydrogen |
| V_{A} | Available volume for hydrogen |
| P_{R} | Required purity for hydrogen |
| P_{A} | Available purity for hydrogen |
| CI_{A} | Available carbon intensity for hydrogen (e.g., |
| | GREET score or other suitable metric) |
| CI_{R} | Required carbon intensity for hydrogen (e.g., |
| | GREET score or other suitable metric) |
| Ave(CPM) | Average transportation cost between the |
| | production location and the customer location |
| | in cost per mile (CPM) |
| Delta(L) | Distance between the production location and |
| | the customer location |
| H₂ Index | Final valuation for hydrogen metric |

The machine learning model can be supervised or unsupervised and used to calculate the spot price and/or normalized hydrogen correction factor and can include: linear regression, models, decision tree regression, convolutional neural networks, long short-term memory networks, recurrent neural networks, generative adversarial networks, radial basis function networks, multilayer perceptrons, self-organizing maps, deep belief networks, Restricted Boltzmann machines, autoencoders and Haar Cascade, and/or the like. In some instances, the machine learning model can be trained based on supplier-provided metrics of hydrogen, customer-supplied metrics for desired/required hydrogen, and/or actual metrics of purchased/delivered hydrogen.

NHCF is the normalized hydrogen correction factor and an output of the machine learning model. The normalized correction factor is a correction to the spot price that provides a new, common, universal, standardized measurement of hydrogen from different and distributed suppliers. With the normalized hydrogen correction factor, exchanging or trading of hydrogen from distributed and different suppliers can be done with a common, universal, and normalized standard.

v_{R} is the required volume for hydrogen (i.e., customer volume data). V_{A} is the available volume for hydrogen (i.e., volume data from telemetry data and/or supplier volume data). The final standard valuation is calculated in the unit of metric ton.

P_{R} is the required purity for hydrogen (i.e., customer purity data). Hydrogen purity or hydrogen quality describes the presence of impurities in hydrogen when used as a fuel gas. The higher the purity, the less impurities exist in hydrogen. Society of Automotive Engineers (SAE) has defined purity standard of hydrogen fuel quality for fuel cell. Hydrogen purity of SAE J2719 grade is defined as a standard purity grade. P_{A} is the available purity for hydrogen (i.e., purity data from the telemetry data and/or supplier purity data).

CI_{R} is the required carbon intensity for hydrogen (i.e., customer carbon intensity data). Carbon intensity is defined as the number of grams of carbon dioxide (CO₂) it takes to make one unit of electricity at one kilowatt per hour (kW/hour). Renewable energy sources produce next to no CO₂ emissions, so the carbon intensity value is much lower and often zero. But there is a high degree of variability in the carbon intensity of hydrogen production, even using the same technologies or pathways, so carbon intensity is essential in determining the standard valuation for hydrogen. Carbon intensity (CI) can be calculated by software algorithm(s), such as an artificial intelligence (AI) model(s) or algorithm(s), a machine learning (ML) model(s) or algorithm(s), an analytical model(s) or algorithm(s), a rule-based model(s) or algorithm(s), or a mathematical model(s) or algorithm(s) and provided as input to the machine learning model for determining normalized hydrogen correction factor. CI of 0.45 kg CO₂/kg H₂ or below is defined as green hydrogen. CI_{A} is the available carbon intensity for hydrogen (i.e., carbon intensity data from the telemetry data and/or supplier carbon intensity data).

In some instances, CI can be adjusted or corrected for transportation and/or storage costs, for example, according to the following equation:

CI_{supplier,Trans}=EF_{CO2,Pipeline}*Frac_{H2,Prod,Pipeline}*Dist_{Pipeline,Wt Av}+EF_{CO2,Truck}*Frac_{H2,Prod,Truck}*Dist_{Truck,1-Way}+EF_{CO2,Rail}*Frac_{H2,Prod,Rail}*Dist_{Rail,1-Way}+EF_{CO2,Air}*Frac_{H2,Prod,Air}*Dist_{Air,1-Way}+EF_{CO2,Sea}*Frac_{H2,Prod,Sea}*Dist_{Sea,1-Way}

| Metric Name | Metric Meaning |
|---|---|
| EF_{CO2, Pipeline} | Emissions Factor for pipeline transportation |
| | of H2 |
| Frac_{H2, Prod, Pipeline} | Fraction of H2 being transported by pipeline |
| Dist_{Pipeline, Wt Av} | Distance of pipeline transportation, weighted |
| | average |
| EF_{CO2, Truck} | Emissions Factor for truck transportation of |
| | H2 |
| Frac_{H2, Prod, Truck} | Fraction of H2 being transported by truck |
| Dist_{Truck, 1-Way} | Distance of truck transportation, 1-way |
| EF_{CO2, Rail} | Emissions Factor for rail transportation of H2 |
| Frac_{H2, Prod, Rail} | Fraction of H2 being transported by rail |
| Dist_{Rail, 1-Way} | Distance of rail transportation, 1-way |
| EF_{CO2, Air} | Emissions Factor for air transportation of H2 |
| Frac_{H2, Prod, Air} | Fraction of H2 being transported by air |
| Dist_{Air, 1-Way} | Distance of air transportation, 1-way |
| EF_{CO2, Sea} | Emissions Factor for sea transportation of H2 |
| Frac_{H2, Prod, Sea} | Fraction of H2 being transported by sea |
| Dist_{Sea, 1-Way} | Distance of sea transportation, 1-way |

In some embodiments a model (e.g., a machine learning model) can be trained or otherwise configured to calculate carbon intensity. Such a model can be different from the machine learning model trained to predict spot price and/or NHCF. Use of such a model may take, as input, supplier data, but can produce a quantitative measure of carbon intensity that is not received directly from the supplier. The model used to calculate carbon intensity can be trained on data associated with reliably assessed hydrogen, such as hydrogen scored using the GREET model. Then, the model used to calculate carbon intensity can take, as an input, suitable supplier data and/or suitable customer data, and predict a carbon intensity. Additionally, the output of a model used to calculate carbon intensity can be an input into the model used to predict spot price and/or NHCF. In some instances, transportation considerations can be accounted for in the model configured to calculate carbon intensity. Because transportation effects are not only supplier-dependent, but are a factor of supplier and customer location and mode of transportation, and because carbon intensity is an input into the model trained to predict spot price and/or NHCF, a computationally challenging recursion problem exists. In some instances, yet another model, different from the model configured to predict spot price and/or NHCF and the model configured to calculate carbon intensity, can be used to predict a transaction price based on supplier and/or customer data (without recursion). The predicted transaction price may not be the actual, final transaction price. The transaction price predicted by that model can be used to match supplier to customer, and once matched, the model configured to calculate carbon intensity can calculate carbon intensity based on customer location, supplier location, and/or mode of transport (e.g., by accessing a database or other repository of available transport modes suitable for connecting supplier to customer). Then, the model trained to predict spot price and/or NHCF can be supplied the carbon intensity output and used to calculate an actual spot price, NHCF, and/or transaction price, thus breaking the recursion challenge.

Referring to FIG. 2, in some embodiments the processor 2501, memory 2502, and/or database 2503 can be operable to match suppliers and customers. For example, supplier(s) can provide a description of available hydrogen (optionally including an ask price), which can be stored in database 2503. In some instances, customer(s) can search for suitable hydrogen and manually identify hydrogen for purchase. In other instances, customer(s) can provide a list of requirements and/or preferences (optionally including a bid price) and the processor 2501 can automatically execute a transaction between customer and supplier. In yet another instance, customers can provide a list of requirements and/or preferences (optionally including a bid price) and supplier(s) can search for suitable customers that can be manually identified for sale.

A machine learning model executing on the processor 2501 can be operable to retrain based on transaction data to determine a spot price. To calculate the spot price, the machine learning model can take, as input one or more of the metrics in table 1 for multiple transactions, as well as (optionally) the price of the transaction, how long the ask and/or bid remained open, duration of the contract, quantity of the contract, etc. Such a machine learning model can also be trained and/or retrained to calculate the normalized hydrogen correction factor for an arbitrary unit of hydrogen, which can be provided to the customer and/or the supplier at 305. Similarly stated, a supplier can input parameters of available hydrogen, and the machine learning model can identify the spot price and predict the standard hydrogen correction factor, which indicates a premium and/or a discount the supplier can be expected to receive relative to the spot price. Similarly, a customer can input requirements and/or preferences, and the machine learning model can identify the spot price and predict the standard hydrogen correction factor, which indicates a premium and/or a discount the customer can be expected to pay relative to the spot price. Typically, the machine learning model will be trained and/or retrained based on past transactions. Similarly stated, the training data set for the machine learning model can include the data from table 1 for executed transactions and include the transaction price. The model can be trained using time variable weighting and/or volume weighted average price trained to predict a price and/or standard hydrogen correction factor for an arbitrary unit of hydrogen, given hydrogen metrics (e.g., table 1 parameters).

Data pre-processing can be done using various techniques including standardization, mean removal, variance scaling, transformation (non-linear and others), data normalization (including z-score scaling, range scaling, clipping, log scaling, and others), discretization, etc.

Model validation can include methods including cross-validation, hyper-parameter tuning, estimator scoring, scoring parameters, metric functions, and validation curves among others.

It should be understood that in some instances a customer or supplier may not specify all input parameters listed in Table 1. For example, a supplier and/or customer may not specify CI. The machine learning model can be operable to calculate a normalized hydrogen correction factor for hydrogen without, for example, a CI score, which would typically be expected to decrease the cost of the hydrogen relative to the spot price. Additional inputs are also possible. For example, hydrogen state (e.g., gas/liquid), pressure, delivery mode (e.g., pipeline, tanker truck, etc.), storage parameters, etc. can be specified.

In some embodiments, the machine learning model can be operable to calculate normalized hydrogen correction factor for suppliers based on available customers and/or vice versa. For example, the processor 2501 and memory 2501 can be operable to calculate a Delta(L), the distance between the production location (i.e., location data from the telemetry data and/or supplier location data) and the customer location (i.e., customer location data) and/or Ave(CPM), the average transportation cost between the production location and the customer location. CPM refers to cost per mile. Weights and factors that can also be determined for each input in table 1 to give discount or incentives for the valuation for hydrogen relative to the spot price and/or matches between supplier and/or customer.

In some embodiments, when customer wants to buy larger volume of hydrogen, i.e., V_{R} is larger, discount may be given to the final calculated price for hydrogen to incentivize exchanging of hydrogen in large volume. In some embodiments, incentives/premiums may be given to customers who would like to purchase hydrogen with high purity. Stated differently, when customer purity data P_{R} is high, more premium/incentives may be given to the final calculated price for hydrogen to incentivize customers to exchange hydrogen with higher purity. In some embodiments, discounts/incentives may be given to customers who want to buy hydrogen with low carbon intensity (i.e., CI_{R} is low). The discounts and incentives for promoting low CI_{R} may come from government incentives such as tax credits from California's Low Carbon Fuel Standard.

In some embodiments, transportation cost (i.e., Ave(CPM)×Delta(L)) may be different for liquid and gas hydrogen. Liquid hydrogen may be cheaper to transport longer distances while gaseous hydrogen may be cheaper to transport shorter distances. Thus, by using information from the customer pressure data to determine whether customer would like to purchase liquid or gaseous version of hydrogen, and comparing to the pressure data from the telemetry data and/or supplier pressure data, different transportation cost (i.e., Ave(CPM)×Delta(L)) can be determined and based on the pressure/form of the hydrogen and the distance between the production location and customer location.

In some embodiments, cost of production can be calculated based on inputs from Table 2 below:

TABLE 2
Parameters for calculation of cost of production

| Metric name | Metric meaning |
|---|---|
| V_{A} | Available volume for hydrogen |
| P_{A} | Available purity for hydrogen |
| CI_{A} | Available carbon intensity for hydrogen |
| L | Location of hydrogen production |
| U | Utility data of hydrogen production |

The cost of production can be calculated by an artificial intelligence (AI) model(s) or algorithm(s), a machine learning (ML) model(s) or algorithm(s), an analytical model(s) or algorithm(s), a rule-based model(s) or algorithm(s), or a mathematical model(s) or algorithm(s) and based on inputs shown in Table 2. V_{A} is the available volume for hydrogen (i.e., volume data from telemetry data and/or supplier volume data). P_{A} is the available purity for hydrogen (i.e., purity data from the telemetry data and/or supplier purity data). CI_{A} is the available carbon intensity for hydrogen (i.e., carbon intensity data from the telemetry data and/or supplier carbon intensity data). L is the location of hydrogen production (i.e., location data from telemetry data and/or supplier location data). U is the utility data of hydrogen production (i.e., utility data from telemetry data and/or supplier utility data). Weights and factors that can be given to each input factor in table 2 to calculate cost of production for hydrogen.

Utility data can be calculated based on inputs from Table 3 below:

TABLE 3
Parameters for calculation of utility cost

| Metric name | Metric meaning |
|---|---|
| NG | Natural gas data |
| E | Electricity data |
| W | Water data |
| LIN | Liquid nitrogen data |
| U | Utility data of hydrogen production |
| F | Feedstock data |

The utility cost can be calculated by an artificial intelligence (AI) model(s) or algorithm(s), a machine learning (ML) model(s) or algorithm(s), an analytical model(s) or algorithm(s), a rule-based model(s) or algorithm(s), or a mathematical model(s) or algorithm(s) and based on inputs shown in Table 3. NG is the natural gas data (i.e., cost of natural gas in production of hydrogen, to include renewable natural gas (RNG) from various sources; landfill gas (LFG), various forms of biowaste, etc.), E is the electricity data (i.e., cost of electricity in production of hydrogen, regardless of the source of the electricity; grid, solar, wind, hydro), W is the water data (i.e., cost of water in production of hydrogen, including wastewater; not including water used in hydroelectric production), LIN is the liquid nitrogen data (i.e., cost of liquid nitrogen in liquefaction and/or production of hydrogen), U is the utility data for additional utilities not enumerated, F is the feedstock data (i.e., NG, off-gas, water). Weights and factors that can be given to each input parameter in table 3 to calculate utility cost in production of hydrogen.

In some embodiments, derivatives of the hydrogen with the normalized hydrogen correction factor can be created and/or offered for exchanging. For example, futures, options, forwards, and swaps of the hydrogen with normalized hydrogen correction factor can be provided for exchanging. A forward contract is an agreement to sell the hydrogen contract at a future date. The price at which this transaction will take place is decided in the present. Forward contract takes place between two customers. A futures contract is very similar to a forward contract, but the futures contract is listed on the platform for trading hydrogen contracts (i.e., the cloud 250 in FIG. 2 for trading hydrogen contract). In an options contract, one party (i.e., customer) has the obligation to buy or sell at a later date whereas the other party (i.e., customer) can make a choice at a later date (i.e. at the expiration of the option). The customer that makes a choice must pay a premium for the privilege. Swaps contracts enable the participants to exchange their streams of cash flows and is the most complicated derivatives among the four. Swaps contracts are not traded on the platform, instead, swap contracts are private contracts which are negotiated between two parties (i.e., customers). By providing derivatives of hydrogen with normalized hydrogen correction factor for exchanging, more flexibility of exchanging can be provided to the customers. Moreover, more profit can be generated which can be shared with the third-party data providers in a waterfall structure to further incentivize third party providers to share data for hydrogen production.

In some embodiments, an apparatus for providing normalized hydrogen correction factor comprises: a set of sensors configured to measure telemetry data of a hydrogen production plant; a memory; a database; and a processor operatively coupled to the memory, the database, and the set of sensors. The processor is configured to: receive the telemetry data from the set of sensors; receive supplier data from the database; receive customer data from a customer; determine, using a machine learning model stored in the memory, and based on the telemetry data, the supplier data, and the customer data, a normalized hydrogen correction factor; and provide the normalized hydrogen correction factor to the customer.

In some embodiments, the telemetry data includes volume data, location data, purity data, carbon intensity data, pressure data, transportation data, and utility data.

In some embodiments, the utility data includes natural gas data, water data, electricity data, and liquid nitrogen data.

In some embodiments, the processor is further configured to calculate a cost of production based on the telemetry data.

In some embodiments, the set of sensors includes catalytic sensors, electrochemical sensors, infrared sensors, pressure sensors, and hydrogen purity sensors.

In some embodiments, the customer data includes customer volume data, customer location data, customer purity data, customer carbon intensity data, customer pressure data, and customer transportation data.

In some embodiments, the database is a distributed database.

In some embodiments, the supplier data includes supplier volume data, supplier location data, purity data, supplier carbon intensity data, supplier pressure data, supplier transportation data, and supplier utility data.

In some embodiments, a method for providing normalized hydrogen correction factor, comprises receiving telemetry data from a set of sensors; receiving supplier data from a database; receiving customer data from a customer. The method further includes determining, using a machine learning model stored in a memory, and based on the telemetry data, the supplier data, and the customer data, a normalized hydrogen correction factor; and providing the normalized hydrogen correction factor to the customer.

In some embodiments, the telemetry data includes volume data, location data, purity data, carbon intensity data, pressure data, transportation data, and utility data.

In some embodiments, the utility data includes natural gas data, water data, electricity data, and liquid nitrogen data.

In some embodiments, the method further comprises calculating a cost of production based on the telemetry data.

In some embodiments, the set of sensors includes catalytic sensors, electrochemical sensors, infrared sensors, pressure sensors, and hydrogen purity sensors.

In some embodiments, the customer data includes customer volume data, customer location data, customer purity data, customer carbon intensity data, customer pressure data, and customer transportation data.

In some embodiments, the database is a distributed database.

In some embodiments, the supplier data includes supplier volume data, supplier location data, purity data, supplier carbon intensity data, supplier pressure data, supplier transportation data, and supplier utility data.

In some embodiments, a non-transitory computer readable medium having stored therein instructions executable by a processor, the instructions are executable to: receive telemetry data from a set of sensors; receive supplier data from a database; receive customer data from a customer. The instructions are further executable to determine, using a machine learning model stored in a memory, and based on the telemetry data, the supplier data, and the customer data, a normalized hydrogen correction factor. The instructions are executable to provide the normalized hydrogen correction factor to the customer.

In some embodiments, the telemetry data includes volume data, location data, purity data, carbon intensity data, pressure data, transportation data, and utility data.

In some embodiments, the utility data includes natural gas data, water data, electricity data, and liquid nitrogen data.

In some embodiments, the instructions further comprise calculating a cost of production based on the telemetry data.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only and are not exhaustive and/or exclusive. Rather, they are presented to assist in understanding and teach the embodiments and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational algorithm, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed:

1. A non-transitory, processor-readable medium storing code, the code comprising instructions configured to be executed by a process to cause the processor to:
receive a plurality of transaction data for sales of hydrogen, each item of transaction data from the plurality of transaction data including price, quantity, carbon intensity, and grade;
train a first machine learning model using the transaction data;
receive supplier data that includes a quantity of available hydrogen and a purity of the available hydrogen;
determine a carbon intensity of the available hydrogen based on the supplier data and using a second machine learning model;
receive customer data from a customer;
determine a normalized hydrogen correction factor for supplying the available hydrogen to the customer using the first machine learning model based on the supplier data, the customer data, and the carbon intensity of the available hydrogen; and
provide the normalized hydrogen correction factor to at least one of the supplier or the customer.

2. The non-transitory, processor-readable medium of claim 1, wherein the code further comprises code to cause the processor to:
determine a spot price for a standard unit of hydrogen; and
apply the normalized hydrogen correction factor to the spot price to calculate a transaction price representing a premium or a discount for the available hydrogen based on the supplier data and the carbon intensity of the available hydrogen.

3. The non-transitory, processor-readable medium of claim 1, wherein at least a portion of the supplier data is received from sensors measuring process parameters at a hydrogen manufacturing plant of the supplier.

4. The non-transitory, processor-readable medium of claim 1, the code further comprising code to cause the processor to facilitate a sale of the available hydrogen to the customer.

5. The non-transitory, processor-readable medium of claim 1, wherein:
the code to cause the processor to receive customer data includes code to cause the processor to receive at least one of a minimum purity, a maximum carbon intensity, or a maximum price, the code further comprising code to cause the processor to:
determine a spot price for a standard unit of hydrogen;
apply the normalized hydrogen correction factor to the spot price to calculate a transaction price representing a premium or a discount for supplying the available hydrogen to the customer based on the supplier data, the customer data, and the carbon intensity of the available hydrogen; and
facilitate a sale of the available hydrogen to the customer at the transaction price based on at least one of the transaction price being at or below the maximum price, the purity of the available hydrogen being at or above the minimum purity, or the carbon intensity being at or below the maximum carbon intensity.

6. The non-transitory, processor-readable medium of claim 5, wherein the code to cause the processor to determine the normalized correction factor is based on a location of the available hydrogen and a delivery location.

7. The non-transitory, processor-readable medium of claim 6, wherein the code to cause the processor to determine the carbon intensity of the available hydrogen is based on the location of the available hydrogen, the delivery location, and a mode of transport from the available location to the delivery location.

8. The non-transitory, processor-readable medium of claim 1, wherein:
the supplier is from a plurality of suppliers;
the code to cause the processor to receive the supplier data includes code to cause the processor to receive a plurality of supplier data from the plurality of suppliers;
the customer is from a plurality of customers;
the code to cause the processor to receive the customer data includes code to cause the processor the receive a plurality of customer data from the plurality of customers; and the code further comprises instructions to cause the processor to:
match a first customer from the plurality of customers to a first supplier from the plurality of suppliers based on customer data associated with the first customer and supplier data associated with the first supplier.

9. The non-transitory, processor-readable medium of claim 1, wherein:
the supplier is a first supplier from a plurality of suppliers;
the code to cause the processor to receive the supplier data includes code to cause the processor to receive a plurality of supplier data from the plurality of suppliers;
the customer is a first customer from a plurality of customers;
the code to cause the processor to receive the customer data includes code to cause the processor the receive a plurality of customer data from the plurality of customers; and the code further comprises instructions to cause the processor to:
match a second customer from the plurality of customers to a second supplier from the plurality of suppliers based on customer data associated with the second customer and supplier data associated with the second supplier; and
facilitate a sale of hydrogen available from the second supplier to the second customer.

10. The non-transitory, processor-readable medium of claim 9, the code further comprising code to cause the processor to:
determine a carbon intensity of the hydrogen available from the second supplier based on a location associated with the second supplier, a location associated with the second customer, and a mode of transport, the second customer matched to the second supplier matched based on the carbon intensity of the hydrogen available from the second supplier.

11. The non-transitory, processor-readable medium of claim 10, wherein:
the normalized correction factor is a first normalized correction factor, the code further comprising code to cause the processor to:
calculate a second normalized correction factor for the hydrogen available for the second supplier based on, the carbon intensity of the hydrogen available from the second supplier, the customer data associated with the second customer, and the supplier data associated with the second supplier.

12. The non-transitory, processor-readable medium of claim 1, wherein the carbon of intensity of the available hydrogen is not determined based on carbon intensity data received from the supplier.

13. A non-transitory, processor-readable medium storing code, the code comprising instructions configured to be executed by a process to cause the processor to:
receive a plurality of customer data from a plurality of customers, each item of customer data including a bid price per unit of hydrogen and at least one of a quantity of desired hydrogen, a minimum purity, or a maximum carbon intensity;
receive a plurality of supplier data from a plurality of suppliers, each item of supplier data including an ask price per unit of hydrogen and at least one of an available purity or an available quantity of hydrogen;
train a first machine learning model to calculate a spot price for a standard unit of hydrogen based on the plurality of customer data and the plurality of supplier data;
match a first customer from the plurality of customers to a first supplier from the plurality of suppliers based on customer data associated with the first customer and supplier data associated with the first supplier;
determine, using a second machine learning model, a carbon intensity of hydrogen supplied to the first customer from the first supplier based on customer data associated with the first customer, including a delivery location, supplier data associated with the first supplier, including an available location, and a mode of transport from the available location to the delivery location;
calculate a normalized hydrogen correction factor based on customer data associated with the first customer, supplier data associated with the first supplier, and the carbon intensity;
calculate a transaction price based on the spot price and the normalized correction factor; and
provide the transaction price to at least one of the first customer or the first supplier.

14. The non-transitory, processor-readable medium of claim 13, the code further comprising code to cause the processor to automatically facilitate a sale of hydrogen from the first supplier to the first customer at the transaction price based on the transaction price being between the bid price and the ask price.

15. The non-transitory, processor-readable medium of claim 14, wherein the code to cause the processor to match the first customer to the second customer includes code to predict that the transaction price will be between the ask price and the bid price before the normalized correction factor is calculated.

16. The non-transitory, processor-readable medium of claim 14, wherein the code to cause the processor to match the first customer to the second customer includes a third machine learning model configured to predict the transaction price without recursively calculating the carbon intensity of hydrogen supplied to the first customer from the first supplier.

17. The non-transitory, processor-readable medium of claim 13, wherein the plurality of supplier data includes second supplier data associated with a second supplier from the plurality of suppliers, the second supplier data including an indication of a right, but not an obligation, to sell hydrogen at a future data.

18. The non-transitory, processor-readable medium of claim 13, wherein the plurality of customer data includes second customer data associated with a second customer from the plurality of customers, the second customer data including an indication of a right, but not an obligation, to buy hydrogen at a future data.

19. The non-transitory, processor-readable medium of claim 13, wherein the code to cause the processor to calculate the carbon intensity of hydrogen supplied to the first customer from the first supplier includes code to cause the processor to access a hydrogen transport database that includes an indication of a plurality of transport modes between the available location and the delivery location.

20. The non-transitory, processor-readable medium of claim 13, wherein the code to cause the processor to calculate the carbon intensity of hydrogen includes code to cause the processor to access utility data associated with a manufacturing plant associated with the first supplier.
